(19) United States
(12) Patent Application Publication
(10) Pub. No.: US 2023/0394511 A1
(43) Pub. Date: Dec. 7, 2023

(54) INTEGRATED SYSTEM AND METHOD FOR DETERMINING CONSUMER INSIGHTS AND ANALYZING MARKET TRENDS

(71) Applicant: ENTERFIVE INC., NW Washington, DC (US)

(72) Inventors: Kemdi EBI, NW Washington, DC (US); Ikezi KAMANU, San Mateo, CA (US); Joshua TABANSI, Lagos (NG); Robert JOHN, Lagos (NG)

(21) Appl. No.: 17/834,787

(22) Filed: Jun. 7, 2022

(51) Int. Cl. G06Q 30/02; G06Q 50/00; G06Q 20/36

(52) U.S. Cl. CPC G06Q 30/0205; G06Q 30/0217; G06Q 50/01; G06Q 20/36

(57) ABSTRACT

An integrated system and method for the determination of consumer insights through social media content and analyzing the market trends. The present integrated system is differentiating from conventional platforms in determining consumer insights by combining three different data results derived from three modules: data listening module to predict consumer sentiment towards a brand or company; a survey module allows customization of survey while targeting a group of participants by defining a set of target demographic attributes; and content creation module allowing content creation by the participants which can be text or media content from a target group of participants and also allows monopolization of such media content.

### FIELD OF THE INVENTION

The subject matter of the present invention relates generally to the field of machine learning implemented in data analysis. Particularly and not exclusively, the subject matter of the present invention is related to an effective and reliable system for consumer data analysis and also allows a user to accumulate monetary credits upon the creation of media content.

### BACKGROUND OF THE INVENTION

One of the critical aspects of the management of brands is to understand the consumer's perspective and acceptance of products or services availed to them. Social listening can be considered an effective method in understanding the market trends and more specifically consumer outlook on certain brands or a subject of interest. Social listening identifies and assesses the reasonings or sentiment of a user from feedback content from various web platforms in relevance to a company, individual, product, or brand. Conversations on the web platform produce massive amounts of unstructured data. Social listening tools can gather and mine the text for specific keywords on social networking websites, blogs and discussion forums, and other social media. Social listening tools can aid companies to identify potential customers and unhappy existing ones; can be implemented to gauge the quality of the customer experience and can collect information to use for return-on-investment monitoring or to evaluate different versions of a campaign to compare how they perform.

Surveying is a technique for gathering statistical information about the attributes, attitudes, or actions of a population by a structured set of questions. Companies can launch demand surveys to evaluate the feasibility of launching a new product or service and also to understand the requirements and necessity for such product to a particular group of audience or customers. Online surveys are wide explored tools to reach customers or consumers on a global scale.

In literature, “An Analysis of Social Listening and Use of Social Media as Marketing Tools Among University Students in Nigeria” it is observed through data analysis that for a business to thrive, irrespective of its category and organizational goals, effective social listening can guide brands in effective running of smart businesses. It is also observed that the use of social media as a marketing tool which when accompanied with effective social listening strategies and actionable plans, will yield tremendous return on investment, and propagate long lasting relationships with customers across the world.

In another literature, “Social listening: a potential game changer in reputation management How big data analysis can contribute to understanding stakeholders' views on organisations”, it is observed that social listening can deliver valuable results for research in the field of management reputation, as it expands the possibilities of investigating public on a large scale. It is also observed that explicit and implicit experiences, which are the drivers of reputation, can be systematically recorded and analyzed using social listening, thus delivering valuable insights as how stakeholders perceive the performance of a company in different dimensions.

It is evident from some case studies like how brands Virgin Trains, Somersby and Play station utilized social listening tools to enhance public sentiment toward the brand or organization. Virgin Trains helped a passenger in need and proved their customer service is unerring, Somersby used social listening to measure the effectiveness of the online campaign and PlayStation increases audience engagement through social media monitoring.

There are the conventional platforms that perform social listening to understand the credibility of a company or brand and there are also multiple web survey tools that can generate surveys and collect data from the general public. The prior U.S. Pat. No. 8,849,826B2 and U.S. Pat. No. 9,201,863B2 are related to a sentiment analysis module configured to gather opinions or determine sentiment expressed in web documents and social media content by extracting keywords from documents, filtering the keywords and documents, and classifying documents, sentences, and/or keywords, to predict the polarity of a sentiment sentence, or social media content. Another patent application US2014012740A is related to a system and method to gather and analyze demographics associated with a plurality of consultants. Surveys are targeted at consultants based, at least in part, on demographic data associated with each consultant's profile. Furthermore, database queries are fulfilled based on the demographic data associated with one or more consultant profiles stored in the database.

Although previously cited patents solve the aspects of social listening and surveying, there is a need for a consumer insight tool designed specifically to tackle the unique obstacles surrounding market data. There is a need for an integrated solution or platform to achieve all the objectives of market analysis and research.

### SUMMARY OF THE INVENTION

One or more implementations of the present specification provide a system, method, and an electronic device for the determination of consumer insights and analyzing the market trends. To achieve the objective above, one or more implementations of the present specification provide the following technical solutions:

The present integrated system is differentiating from conventional platforms in determining consumer insights by combining three different data results derived from three modules: data listening, survey module, and content creation module.

The first aspect of the one or more implementations of the present specification is to provide an efficient, reliable, and integrated data listening module and method for determination of consumer insights through social media content and analyzing the market trends. The consumers' insights can be derived from the multiple channels of social media and customized data sets generated by the present system which are further processed by a sentiment analysis engine to predict and derive the sentiment of consumers towards such company, or brand. The keywords are extracted from multiple media content channels and these keywords are further translated, filtered, predicted, and classified under positive, negative, or neutral groups and displayed on an application interface for easy comprehension. The translation can be achieved in multiple languages and the keywords are categorized concerning with language. The sentiment analysis is performed on multiple languages simultaneously to determine the sentiment under positive, neutral, or negative categories which are further weighed against the other relevant quality metrics to understand the public sentiment in respect with demographics or geographic region.

In accordance with the first aspect, the user registered for the present system can filter the attributes like several data sources, sentiment distribution, time series data, geographic data, and demographic data can be filtered to generate a graphical representation of the consumer sentiment and monitor market trends effectively. Also, identifying influencers, and competitors to derive a comparative analysis with such competitors can be achieved through the filtering and categorization aspects of the data listening module of the present system.

The second aspect of the present integrated system is to allow the creation of social profiles by the users on an application interface and the system will store such accumulated demographic details of the users that can be further utilized for relevant survey targeting. The users can be an organization or individual customer and the users are allowed to participate in the surveys and content creation based on the requests from the producers, brands, or even an individual to analyze the market trends. Following the present system, the users can receive “text content” or “media content” based requests, wherein the “text content” is the survey participation request while “Media content” requests are the multimedia requests to complete tasks assigned based on the demographic data of the user. The responses of the text content and media content are updated in real-time on the application interface of the present system. The users are then provided monetary incentives upon content creation and participation in a customized survey.

The third aspect of the present specification, the survey module facilitates the generation of a customized list of surveys to a user based on the collected demographic data of the user. The integrated system has access to a network of users (customers or consumers) and entities (like brand or company), can define a group of participants among the network of users, based on the accumulated demographic attributes, and send out surveys to obtain insight from such target participants. The survey module allows for post-survey filtering, such that the entities can discover a specific cohort within their participants to verify how the answers differ from the greater demographic. The participants of the survey are provided incentives and the virtual wallet of the participant is credited upon completion of the survey.

Following the third aspect, the survey module can generate a strong and unique application interface with technical and competitive advantages leading to an automated targeted survey to observe user behavior that can generate a customized data set concerning each user individually, wherein the data set comprises distinct personal facts about each user. The survey module can employ potential analysis of voice, face, etc. to define the personality traits of the user and evaluate their preferences. The voice and face analysis can be achieved through voice recognition, face detection, emotion classification, pose recognition, and gesture analysis. Such input data can be acquired through sound and image capturing devices integrated with the users' mobile devices like smartphones, laptops, systems, wearable devices, and the like. This application interface can further allow users or platform administrators to produce a generic or specific persona from the value proposition or similar data.

The fourth aspect of the present specification is a content creation module that allows the user to create media content. The entities (like brands or company or organization) can engage with a network of participants (customers or consumers) and can send requests to create and share media content like a photo, video, or audio snippet of their liking. The content created by each participant is protected and updated in a smart contract to facilitate the reservation of all the (copyright) of such media content to the participant. The smart contract facilitates potential monetization of the media content by the participant. The participants (users) who comply with content creation requests and after acceptance of such media content, are provided incentives and the virtual wallet is credited upon completion of the assigned task of content creation. The post-request supplementary filtering can be defined on target demographic data and can access unique and scalable content.

Other objects, aspects, features, and goals of the present invention will be better understood from the following detailed description. The following description is illustrative and is not intended to be in any way limiting. In addition to the illustrative aspects, embodiments, and features described above, further aspects, embodiments, and features will become apparent by reference to the following detailed description.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein reference letters and numerals indicate the corresponding parts in various figures in the accompanying drawings, and in which:

FIG. 1 illustrates a schematic block diagram of the integrated system and application interface for determining consumer insights and analyzing market trends.

FIG. 2 illustrates a schematic structural diagram of the integrated system in accordance with the exemplary embodiment of the present specification.

FIG. 3 illustrates a schematic structural diagram of the data listening module of the integrated system in accordance with the exemplary embodiment of the present specification.

FIG. 4 illustrates a schematic structural diagram of the survey module of the integrated system in accordance with the exemplary embodiment of the present specification.

FIG. 5 illustrates a schematic structural diagram of the content creation module of the integrated system in accordance with the exemplary embodiment of the present specification.

FIG. 6 illustrates a process flow of the data listening module in accordance with the most preferred embodiment of the present specification.

FIG. 7 illustrates a process flow of the survey module in accordance with the most preferred embodiment of the present specification.

FIG. 8 illustrates a process flow of the content creation module in accordance with the most preferred embodiment of the present specification.

FIG. 9 illustrates the interaction between the user application interface and integrated system according to an exemplary embodiment of the present specification.

FIG. 10 illustrates the application interface of the data listening module in accordance with the most preferred embodiment of the present specification.

FIG. 11 illustrates the application interface of the survey module in accordance with the most preferred embodiment of the present specification.

FIG. 12 illustrates the application interface of the content creation module in accordance with the most preferred embodiment of the present specification.

### DETAILED DESCRIPTION OF THE PREFERRED AND ILLUSTRATED EMBODIMENTS OF THE PRESENT INVENTION

Example implementations are described in detail here, and examples of the example implementations are presented in the accompanying drawings. The implementations described in the following example implementations do not represent all implementations that are consistent with one or more implementations of the present specification. On the contrary, the implementations are only examples of apparatuses and methods that are described in the appended claims in detail and consistent with some aspects of one or more implementations of the present specification.

It is worthwhile to further note that the term “include”, “contain”, or any other variant is intended to cover a non-exclusive inclusion, so that a process, a method, merchandise, or a device that includes a list of elements not only includes those elements but also includes other elements which are not expressly listed, or further includes elements inherent to such process, method, merchandise, or device.

The present specification is related to an effective, reliable, and integrated system and method for the determination of consumer insights through social media content and analyzing market trends. The consumer insights can be derived from the multiple channels of social media and consumers' insights can be analyzed towards such companies, or brands. The present integrated system is differentiating from conventional platforms in determining consumer insights by combining three different data results derived from three modules: data listening, survey module, and content creation module.

In the most preferred embodiment of the present specification, the integrated system can facilitate data listening to predict consumer sentiment towards a brand or company; can allow customization of a survey targeting a group of participants by defining a set of target demographic attributes, and allow content creation by the participants which can be text or media content from a target group of participants.

In accordance with the most preferred embodiment of the present specification, the data listening module can predict sentiment through a sentiment analysis engine. The engine facilitates keywords extraction from multiple media content channels and these keywords are further translated, filtered, predicted, and classified under positive, negative, or neutral groups and displayed on an application interface for easy comprehension. The filtered results can further generate a graphical representation of the consumers' sentiment. The data listening module can identify influencers, and competitors to derive a comparative analysis with such competitors.

In accordance with the most preferred embodiment of the present specification, the integrated system facilitates the creation of social profiles by the users on an application interface and the system will store such accumulated demographic details of the users that can be utilized for relevant survey targeting. The users can be an organization or a customer. The users are allowed to participate in the surveys and content creation based on the requests from the producers, brands, or even an individual to analyze the market trends. The responses to the survey and media content are updated in real-time on the application interface of the present system. In accordance with the invention, the integrated system allows sanction of monetary incentives to the participants upon content creation and participation in a customized survey.

In accordance with the most preferred embodiment of the present specification, the integrated system comprises a survey module that facilitates the generation of a customized list of surveys to a user based on the collected demographics of the user. The survey module has access to a network of users (customers or consumers) and entities (like brand or company), can define a group of participants among the network of users, based on the accumulated demographic attributes, and send out surveys to obtain insight from such target participants. The survey module allows for post-survey filtering, such that the entities can discover a specific cohort within their participants to verify how the answers differ from the greater demographic.

In accordance with the most preferred embodiment of the present specification, the integrated system comprises a content creation module that allows the user to create media content. The entities (like brands or a company) can engage with a network of participants (customers or consumers) and can send requests to create and share media content like a photo, video, or audio snippet of their liking. The content created by each participant is protected and updated in a smart contract to facilitate the reservation of all the (copyright) of such media content to the participant. The smart contract facilitates potential monetization of the media content by the participant.

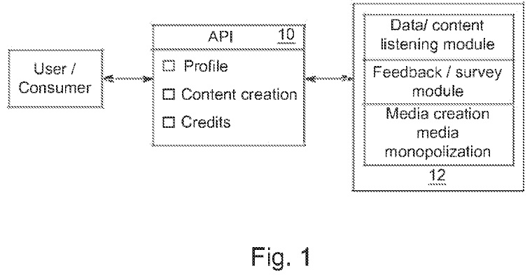

Referring to FIG. 1 is a schematic block diagram of the integrated system 12 and application interface 10 of a consumer or user. The integrated system 12 derives consumer insights and analyze the market trends which are further achieved through the data listening module, survey module, and content creation module wherein the listening module can predict the sentiment of the consumer towards a particular brand or company, the survey module facilitates on demand surveying and content creation is a value-added service which facilitates content creation to determine insight of the customers.

The application interface 10 is a user API which is an intermediary platform for the users to compute the integrated system 12. The application interface 10 can facilitate the creation of user social profiles and the demographic data derived from the profile data, that are further stored in the integrated system 12. The user can share the content created through application interface 10 and the responses received are updated on the user profile. The user can also access the virtual credit wallet through this interface 10.

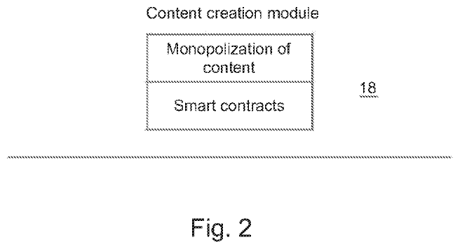

Referring to FIG. 2 is a schematic structural diagram of the integrated system 12 in accordance with the exemplary embodiment of the present specification. The integrated system 12 comprises data listening module 14 to predict consumer sentiment towards a brand or company; a survey module 16 allows customization of the survey while targeting a group of participants by defining a set of target demographic attributes; and content creation module 18 allows content creation by the participants which can be text or media content from a target group of participants and also allows monopolization of such media content.

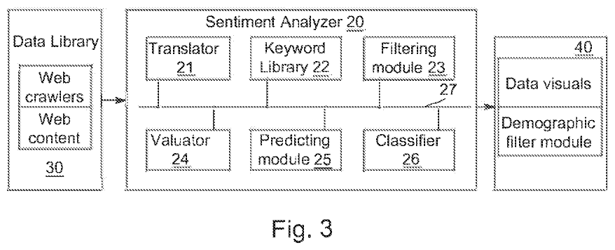

Referring to FIG. 3 is a schematic structural diagram of the data listening module of the integrated system in accordance with the exemplary embodiment of the present specification. The data listening module accumulates dataset 30 from multiple web-based channels. The data is collected from popular social network sites, and web crawlers can track any formal mentions on global and local news publications, and more informal sources, alternative media, like popular local blogs and forums relevant to the country in which the entity (company) is tracking. The data 30 is fed to a sentiment analyzer 20 which comprises a translator 21 which can facilitate multi-language translation and understanding the language nuances thereby categorizing, a keyword module 22 configured to extract keywords from translated documents, a filtering module 23 configured to filter keywords and documents, a valuator 24 configured to evaluate the filtered keywords, a sentiment predictor module 25 configured to predict the sentiment from the valuated filtered keywords and a classifier 26 to classify the keywords. The functionality of these modules may be combined with each other or in addition to other modules. The translator 21, keyword module 22, the filtering module 23, valuator 24, sentiment predictor module 25, and classifier 26 are coupled to a communication bus 27.

The translation can be achieved in multiple languages and the keywords are categorized in relation to language. The sentiment analysis is performed on multiple languages simultaneously to determine the sentiment under positive, neutral, or negative categories which are further weighed against the other relevant quality metrics to understand the public sentiment with respect to demographics or geographic region. The keywords are classified as positive, negative, or neutral sentimental keywords words and the results are displayed on the application interface 10 for easy comprehension. The user can further define filtering attributes like a number of data sources, sentiment distribution, time series data, geographic data, and demographic data to the obtained sentiment analysis results by the data listening module. The filtered results can further generate a graphical representation 40 of the consumers' sentiment.

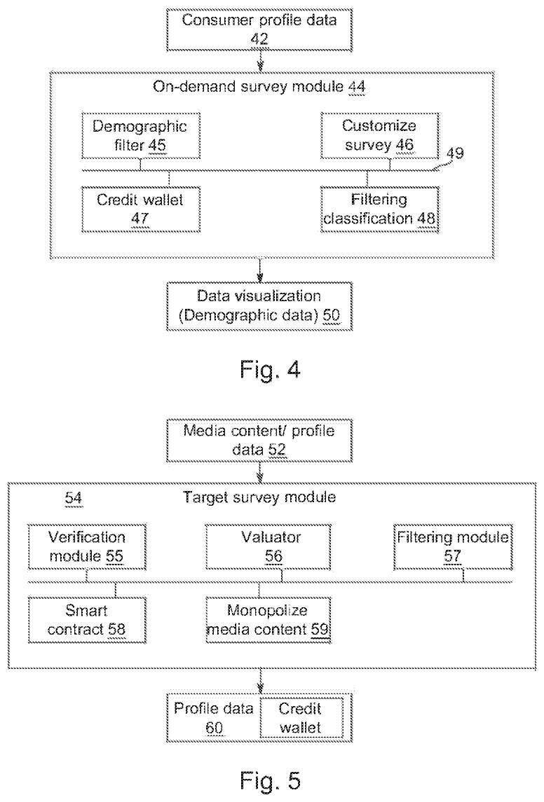

Referring to FIG. 4 is a schematic structural diagram of the survey module of the integrated system in accordance with the exemplary embodiment of the present specification. The survey module has access to a network of user (customers or consumers) profile data 42 and entities (like brand or company). The survey module generates a customized survey 46 by defining the criteria for the participants based on demographic data filtering 45, and the user virtual wallet 47 is credited after completion of a survey and the results of the survey can be further filtered or classified 48 by defining filtering attributes like a number of data sources, sentiment distribution, time series data, geographic data, demographic data. The filtered results can further generate a graphical representation 50 of the consumers' insights.

The survey module 16 can generate a strong and unique application interface with technical and competitive advantages leading to an automated targeted survey to observe user behavior that can generate a customized data set with respect to each user individually, wherein the data set comprises distinct personal facts about each user. Survey module 16 can employ potential analysis of voice, face, etc. to define the personality traits of the user and evaluate their preferences. The voice and face analysis can be achieved through voice recognition, face detection, emotion classification, pose recognition, and gesture analysis. Such input data can be acquired through sound and image capturing devices integrated with the users' mobile devices like smartphones, laptops, systems, wearable devices, and the like. This application interface can further allow users or platform administrators to produce a generic or specific persona from the value proposition or similar data.

Referring to FIG. 5 is a schematic structural diagram of the content creation module of the integrated system in accordance with the exemplary embodiment of the present specification. The entities (company) can request “Media content” which can be multimedia requests to complete tasks assigned based on the demographic data of the user (consumer or customer). The created media content 52 is fed to the content creation module 54 which comprises a verification module 55 configured to verify the shared media content, a valuator 56 to evaluate the media content and the accepted media content is updated in smart contracts 58, a post request supplementary filtering unit 57 configured to define target demographic filtering data and can access only such results and a media monopolize unit 59 to facilitate the reservation of all rights of the media content to the user. The valuated and accepted media content is awarded incentives and the virtual wallet 60 is credited upon completion of the assigned task of content creation.

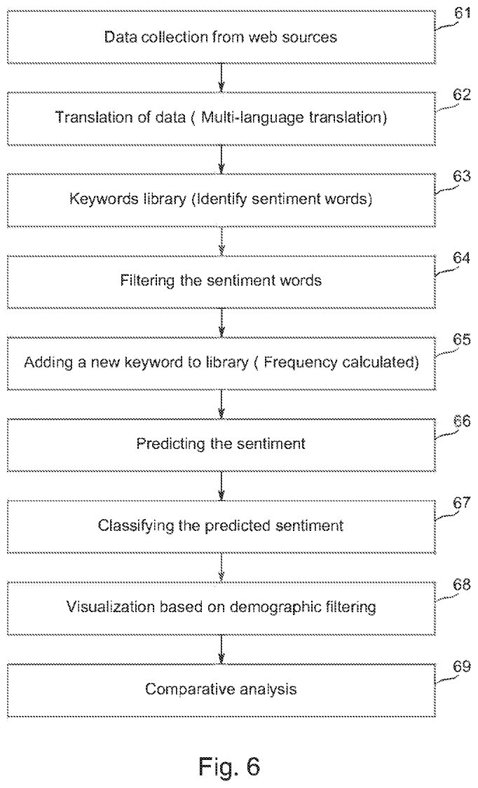

FIG. 6 illustrates a process flow of data listening module wherein the sentiment of the consumers with respect to a company is determined by the following steps: a collection of data from web sources at s61; translation of the data (also multi-language translation) at s62; extracting the keywords from the translated data at s63; filtering the extracted keywords into sentimental and non-sentimental keywords at s64; adding a new keyword to the keyword library at s65; predicting the sentiment from the filtered keywords at s66; classifying the predicted sentiment words into positive, neutral and negative classes at s67; visualizing the results by defining filter attributes at s68; and deriving comparative analysis at s69.

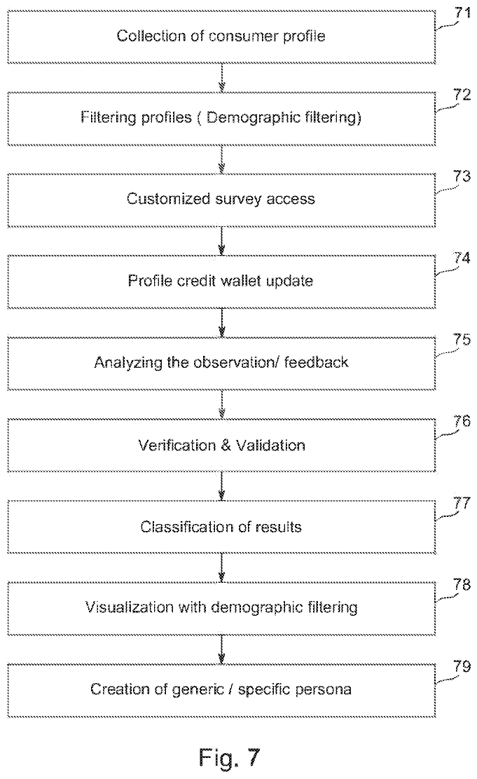

FIG. 7 illustrates a process flow of the survey module wherein the generation of a customized survey comprises steps: collecting the user profile data at s71; filtering the demographic data according to the required attributes for the target participants at s72; providing access to the customized survey at s73; updating the virtual credit wallet at s74; analyzing the results of the survey at s75; verifying and validating the results of the survey at s76; filtering the results by defining filter attributes at s77; visualizing the results at s78; and generation of a specific or general persona by the user or administrator using datasets or value proportions provided through application interface at s79.

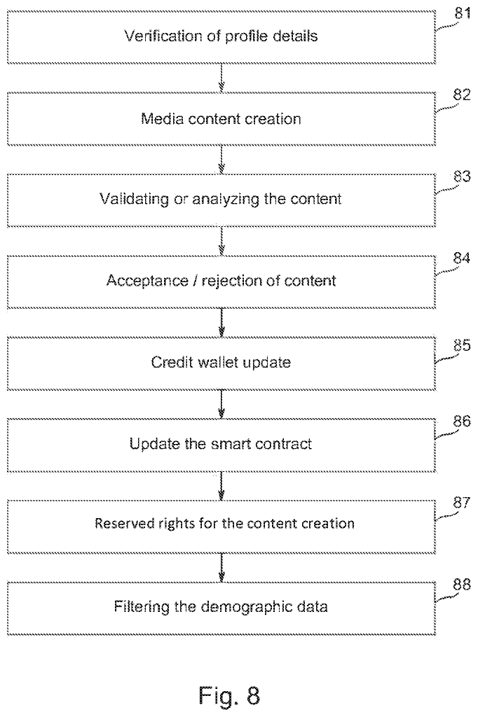

FIG. 8 illustrates a process flow of the content creation module wherein the creation and validation of the media content comprises steps: verifying the demographic details of the participant and requesting the content sharing at s81; creating a media content to comply with the assigned task or request at s82; validating and analyzing the media content at s83; approving or rejecting the content s84; if accepted virtual credit wallet updated at s85; updating the smart contract at s86; monopolizing the media content rights to the user at s87; and post request supplementary filtering of the results by defining filter attributes (like gender, income, educational background) at s88.

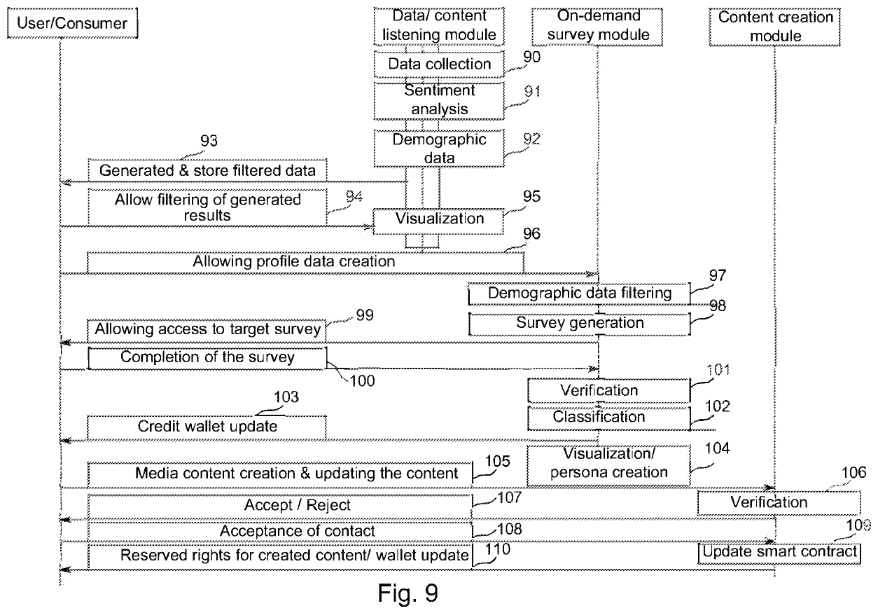

FIG. 9 illustrates the interaction between the user application interface and integrated system modules in accordance with an exemplary embodiment of the present specification. The data listening module collects the data from web sources 90; performing sentiment analysis on data 91; filtering by defining demographic attributes 92; generating and storing the filtered results on the user application interface 93; allowing filtering of results by defining attributes 94; visualizing of the results 95. The survey module collects the created user profile data 96; initiates demographic data filtering 97; generating customized survey 98; allowing access to complete a survey to the user 99; completion of survey 100; verification of results 101; classifying and filtering of results 102; crediting the virtual wallet 103 and visualization of the filtered results and generation of specific or general persona for each user through application interface 104. The content creation module allows the user to share the media content 105; verification of the media content 106, approval or rejection of the media content 107; if the content is accepted 108 updates the smart contract 109 and monopolize the rights of the content to the user and update the credit wallet 110.

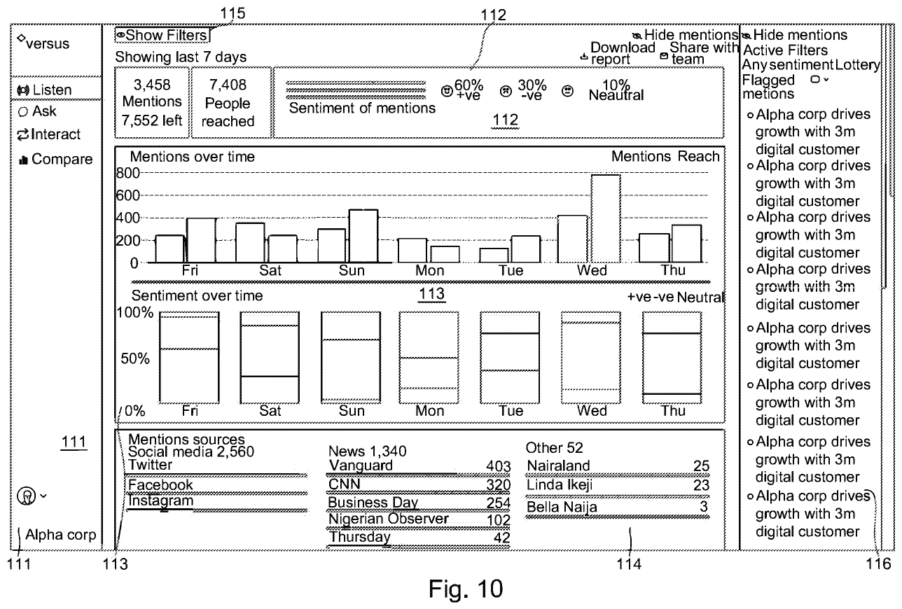

Referring to FIG. 10 is the overview of the application interface of data listening module 14 on user application depicting a control panel 111 comprising the three modules of the present system i.e, data listening, survey, and content creation modules, and comparative analysis module to compare the generated results among different entities (company or brand). The sentiment categorization is represented in section 112 and graphical representation of the sentiment analysis in section 113 and the data collected from the social media sources is defined by metrics in section 114. The data listening module 14 allows filtering 115 of the generated results of the sentiment analysis using demographic attributes. The interface also comprises a separate section 116 for providing updates on business entities.

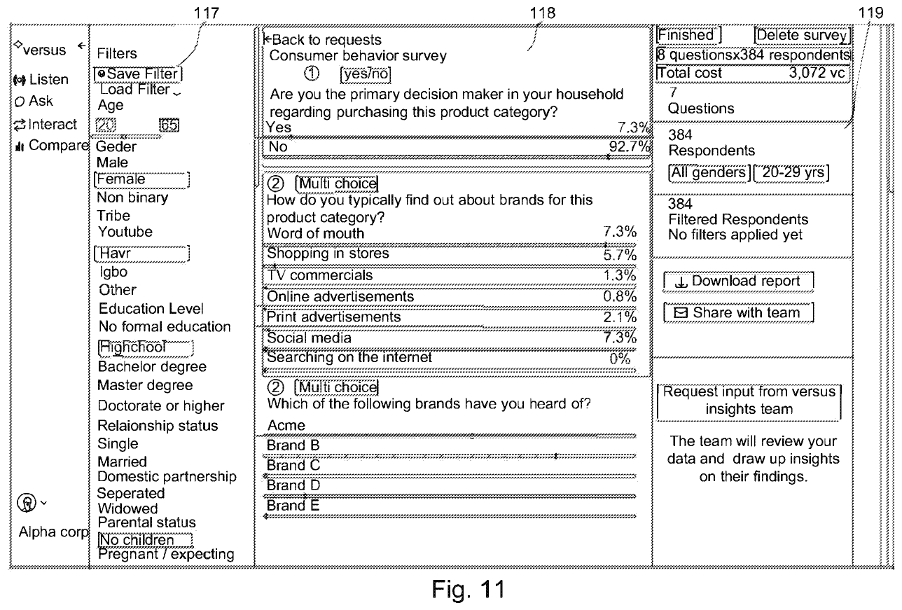

Referring to FIG. 11 is the overview of the survey module 16 on user application having filter section 117 for post survey filtering and the results of the applied filters can be viewed with metric data in section 118 and a control panel 119 for the user to perform other miscellaneous tasks like deleting the survey or to view the general metrics data like a total number of participants, mostly answered queries in the survey and other metrics depicted with numeral representation.

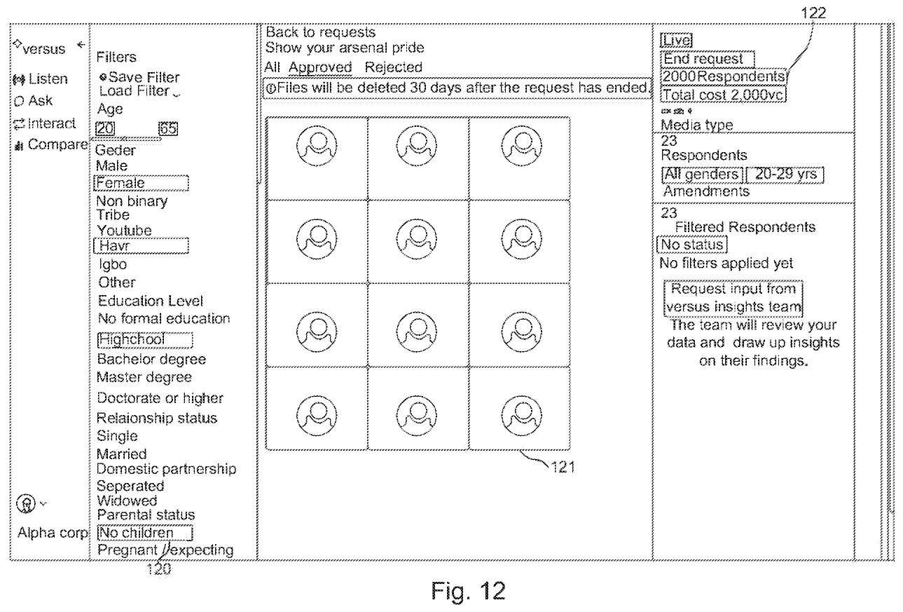

Referring to FIG. 12 is the overview of the content creation module 18 on admin application having filter section 120 for post request supplementary filtering and the results of the applied filters can be viewed in section 121 depicting media content from various users and a control panel 122 for the admin to perform other miscellaneous tasks like ending the request for media content or to view the general metrics data like a total number of participants, mostly answered queries in the survey and other metrics depicted with numeral representation.

The system, apparatus, module, or unit described in the implementations above can be implemented by using a computer chip or an entity can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or a combination of any of these devices.

The computer-readable medium includes persistent, non-persistent, movable, and unmovable media that can implement information storage by using any method or technology. Information can be a computer readable instruction, a data structure, a program module, or other data. A computer storage medium includes but is not limited to phase-change random access memory (PRAM), a static random access memory (SRAM), a dynamic random access memory (DRAM), a random access memory (RAM) of another type, a read-only memory (ROM), an electrically erasable programmable read-only memory (EEPROM), flash memory or another memory technology, a compact disc read-only memory (CD-ROM), a digital versatile disc (DVD) or another optical storage, a magnetic tape, magnetic disk storage, a quantum memory, a graphene-based storage medium, another magnetic storage device, or any other non-transmission medium. The computer storage medium can be used to store information that can be accessed by a computing device based on the definition in the present specification, the computer readable medium does not include transitory computer readable medium (transitory media), for example, a modulated data signal and carrier.

Embodiments and the operations described in this specification can be implemented in digital electronic circuitry, or computer software, firmware, or hardware, including the structures, disclosed in this specification or combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, multiple ones, or combinations, of the foregoing.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or another unit suitable for use in a computing environment. A computer program can be executed on one computer or on multiple computers that are located at one site or distributed across multiple sites and interconnected by a communication network.

Processors for the execution of a computer program include, by way of example, both general- and special-purpose microprocessors, and any one or more processors of any kind of digital computer. Generally, a processor will receive instructions and data from a read-only memory or a random-access memory, or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data.

Mobile devices can include handsets, user equipment (UE), mobile telephones (for example, smartphones), tablets, or other types of mobile devices. Mobile devices can communicate wirelessly (for example, using radio frequency (RF) signals) to various communication networks (described below). The mobile devices can include sensors for determining the characteristics of the mobile device's current environment. The sensors can include cameras, microphones, GPS sensors, motion sensors, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, or RF sensors, can be used for user authentication.

To provide for interaction with a user, embodiments can be implemented on a computer having a display device and an input device, for example, a liquid crystal display (LCD) or organic light-emitting diode (OLED for displaying information to the user and a touchscreen, keyboard, and a pointing device by which the user can provide input to the computer.) In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or a combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that action and a response are temporally proximate.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, authentication data, or other information between the connected computing devices.

Features described as separate implementations may be implemented, in combination, in a single implementation, while features described as a single implementation may be implemented in multiple implementations, separately, or in any suitable sub-combination. Operations or processes or methods described and claimed in a particular order should not be understood as requiring that the particular order, nor that all illustrated operations must be performed (some operations can be optional). As appropriate, multitasking or parallel-processing (or a combination of multitasking and parallel-processing) can be performed.

Specific implementations of the present specification are described above. Other implementations fall within the scope of the appended claims. In some situations, the actions or steps described in the claims can be performed in an order different from the order in the implementations and the desired results can still be achieved. In addition, the process described in the accompanying drawings does not necessarily need a particular execution order to achieve the desired results. In some implementations, multitasking and parallel processing can be advantageous.

The descriptions above are only example implementations of one or more implementations of the present specification but are not intended to limit one or more implementations of the present specification. Any modification, equivalent replacement, improvement, etc. made without departing from the scope and principle of the one or more implementations of the present specification shall fall within the protection scope of the one or more implementations of the present specification.

What is claimed is:

1. An integrated system for determination of consumer insights and analysis of market trends, such integrated system comprises:
a. data listening module to predict consumer sentiment towards an entity through a sentiment analyzer which comprises
a translator which can facilitate multi-language translation;
a keyword module configured to extract keywords from translated documents;
a filtering module configured to filter keywords and documents;
a valuator configured to evaluate the filtered keywords;
a sentiment predictor module configured to predict the sentiment from the valuated filtered keywords; and
a classifier to classify the keywords;
b. a survey module to generate a strong and unique application interface with technical and competitive advantages leading to an automated targeted survey to observe user behavior that can generate a customized data set concerning each user individually, wherein the data set comprises distinct personal facts about each user, which are further processed to produce a specific or general persona for each user; and
c. content creation module allowing content creation by the participants which further comprises:
a verification module configured to verify the shared media content;
a valuator to evaluate the media content and the accepted media content is updated in smart contracts;
a post request supplementary filtering unit configured to define target demographic filtering data and can access only such results; and
a media monopolize unit to facilitate the reservation of all rights of the media content to the user;
wherein the integrated system is computed by a user through an intermediary platform like an application interface that is a user API,
wherein the integrated system is a differentiating platform that determines the consumer insights by combining three different data results derived from three modules: data listening module, survey module, and content creation module.

2. The system according to claim 1, wherein the application interface allows the creation of user social profile, and the demographic data derived from the profile data are further stored in the integrated system.

3. The system according to claim 1, wherein the application interface allows the user access to a virtual credit wallet.

4. The system according to claim 1, wherein the translator, the keyword module, the filtering module, the valuator, the sentiment predictor module, and the classifier are coupled to a communication bus in the sentiment analyzer.

5. The system according to claim 1, wherein the data is fed into the sentiment analyzer of the data listening module from multiple web-based channels, social network sites, any formal mentions on global and local news publications, and more informal sources, alternative media, like popular local blogs and forums relevant to the country.

6. The system according to claim 1, wherein the classified results of the sentiment analysis can be further filtered by defining the filtering attributes like a number of data sources, sentiment distribution, time series data, geographic data, and demographic data.

7. The system according to claim 1, wherein the data listening module facilitates identifying influencers, and competitors to derive a comparative analysis with such competitors through filtering and categorization.

8. The system according to claim 1, wherein the survey module generates a customized survey by defining the criteria for the participants based on demographic data filtering, and the user's virtual wallet is credited after completion of the survey and the results of the survey can be further filtered or classified by defining filtering attributes like a number of data sources, sentiment distribution, time series data, geographic data, demographic data.

9. The system according to claim 1, wherein the survey module can employ potential analysis of voice, face, etc. to define the personality traits of the user and evaluate their preferences, wherein the voice and face analysis can be achieved through voice recognition, face detection, emotion classification, pose recognition, gesture analysis.

10. The system according to claim 1, wherein the virtual credit wallet of the user is credited after completion of the assigned survey and approval of the created media content by the content creation module.

11. A method for determining the consumer insights, such method comprising steps of:
a. determining the sentiment of the consumers concerning a company, through a sentiment analyzer comprising a translator which can facilitate multi-language translation; a keyword module configured to extract keywords from translated documents; a filtering module configured to filter keywords and documents; a valuator configured to evaluate the filtered keywords; a sentiment predictor module configured to predict the sentiment from the valuated filtered keywords, and a classifier to classify the keywords;
b. generating customized survey through a strong and unique application interface with a technical and competitive advantage to observe user behavior that can generate a customized data set concerning each user individually, wherein the data set comprises distinct personal facts about each user, which are further processed to produce a specific or general persona for each user; and
c. allowing media content creation and validation through the content creation module which comprises a verification module configured to verify the shared media content; a valuator to evaluate the media content and the accepted media content is updated in smart contracts; a post request supplementary filtering unit configured to define target demographic filtering data and can access only such results, and a media monopolize unit to facilitate the reservation of all rights of the media content to the user;
wherein the consumer insights are understood and derived by combining data results derived data listening module, survey module, and content creation module.

12. A method for determining the sentiment of the consumers through sentiment analyzer, comprising steps:
collecting data from web sources;
translating the data (also multi-language translation);
extracting the keywords from the translated data;
filtering the extracted keywords into sentimental and non-sentimental keywords;
adding a new keyword to the keyword library;
predicting the sentiment from the filtered keywords;
classifying the predicted sentiment words into positive, neutral, and negative classes;
visualizing the results by defining filter attributes; and
deriving comparative analysis.

13. The method according to claim 12, wherein the data is fed into the sentiment analyzer of the data listening module from multiple web-based channels, social network sites, any formal mentions on global and local news publications, and more informal sources, alternative media, like popular local blogs and forums relevant to the country.

14. The method according to claim 12, wherein the classified sentiment analysis can be further filtered by defining the filtering attributes like a number of data sources, sentiment distribution, time series data, geographic data, and demographic data.

15. The method for generating a customized survey through the survey module comprises steps:
collecting the user profile data;
filtering the demographic data according to the required attributes for the target participants;
providing access to customized surveys;
updating the virtual credit wallet;
analyzing the results of the survey;
verifying and validating the results of the survey;
filtering the results by defining filter attributes;
visualizing the results; and
generating specific or general persona for each user to observe the distinct personality traits of the user.

16. The method according to claim 15, wherein a customized survey is generated by defining the criteria for the participants based on demographic data filtering and the results of the survey can be further filtered or classified by defining filtering attributes like a number of data sources, sentiment distribution, time series data, geographic data, demographic data.

17. The method according to claim 15, wherein the survey module can employ potential analysis of voice, face, etc. to define the personality traits of the user and evaluate their preferences, wherein the voice and face analysis can be achieved through voice recognition, face detection, emotion classification, pose recognition, gesture analysis.

18. A method for creating and validating the media content through a content creation module comprising steps:
verifying the demographic details of the participant and requesting the content sharing;
creating media content to comply with the assigned task or request;
validating and analyzing the media content;
approving or rejecting the content;
updating the virtual credit wallet if the media content is validated;
updating the smart contract;
monopolizing the media content rights to the user; and
post request supplementary filtering of the results by defining filter attributes to access unique and scalable content.

19. The method according to claim 18, wherein the filter attributes can be demographic attributes like gender, income, and educational background.
